(19) United States
(12) Patent Application Publication
(10) Pub. No.: US 2009/0067185 A1
(43) Pub. Date: Mar. 12, 2009

(54) Lamp Assembly for Motorcycle

(75) Inventor: Mark Blankers, Lomita, CA (US)

Correspondence Address: HOGAN & HARTSON L.L.P., 1999 AVENUE OF THE STARS, SUITE 1400, LOS ANGELES, CA, 90067, US

(73) Assignee: YAMAHA MOTOR CORPORATION, USA, Cypress, CA (US)

(21) Appl. No.: 12/205,592

(22) Filed: Sep. 5, 2008

Related U.S. Application Data
(60) Provisional application No. 60/967,923, filed on Sep. 7, 2007.

(51) Int. Cl. B62J 6/00

(52) U.S. Cl. 362/473

(57) ABSTRACT

A lamp assembly for a vehicle including a passing lamp and a turn signal. A passing lamp is mounted within one portion of a housing of the lamp assembly, and a turn signal is mounted within another portion of the housing. A controller turns the passing lamp OFF when the turn signal is turned ON. The turn signal comprises a plurality of LED lamps that may be operated at a relatively high brightness to operate as a turn signal, and at a relatively low brightness to operate as running lamps. A male spline in the lamp assembly received with a female spline of a lamp mount allows adjustment of a horizontal alignment of the lamp assembly.

### CROSS-REFERENCE TO RELATED APPLICATION

This application claims the benefit of priority under 35 USC 119 of U.S. provisional application No. 60/967,923, filed on Sep. 7, 2007, which is incorporated herein by reference.

### BACKGROUND OF THE INVENTION

1. Field of the Invention

The present invention relates generally to lamp assemblies for motorcycles and, more particularly, relates to a combined passing lamp and turn signal assembly for a motorcycle.

2. Description of Related Art

Saddle-type vehicles such as motorcycles are typically provided with a headlight to provide illumination at night and under low-lighting conditions. Turn signal lights to signal left and right turns are also typically provided. Other types of lighting, such as passing lamps, may also be added as accessories in order to provide greater or different (i.e. fog conditions) amounts of illumination, as well as to enhance the appearance of the motorcycle

Mounting multiple and various sources of illumination to a motorcycle is problematic due to the limited mounting area and surfaces available on a motorcycle. Bracket-type mounting assemblies have been provided to which both turn signals and passing lamps may be mounted. Known assemblies, however, suffer from various drawbacks. It is often difficult and unwieldy to mount separate passing lamp and turn signal assemblies onto a single bracket or mount. Moreover, the mounted lamps or lights are usually fixed relative to the mount and cannot be adjusted. Where adjustable, the means for adjusting the lamps have been difficult to access and have not provided a great range of adjustment.

### SUMMARY OF THE INVENTION

The present invention provides a lamp assembly for a motorcycle that overcomes the drawbacks and disadvantages of prior art lighting assemblies.

A lamp assembly according to the invention includes a passing lamp mounted within one portion of a housing, and a turn signal mounted within another portion of the housing.

In one embodiment, a controller turns the passing lamp OFF when the turn signal is turned ON.

In another embodiment, the turn signal comprises a plurality of LED lamps that may be operated at a relatively high brightness to operate as a turn signal, and at a relatively low brightness to operate as running lamps.

In another embodiment, a male spline in the lamp assembly received with a female spline of a lamp mount allows adjustment of a horizontal alignment of the lamp assembly.

Other features and advantages of the invention will be apparent from the following detailed description, taken in conjunction with the accompanying drawings which illustrate, by way of example, various features of embodiments of the present invention.

### BRIEF DESCRIPTION OF THE DRAWINGS

FIG. 1 is a perspective view of a lamp assembly according to the present invention.

FIG. 2 is another perspective view of the lamp assembly.

FIG. 3 is a side view of the lamp assembly.

FIG. 4A is a plan view of a male-splined shaft for horizontal alignment according to the present invention.

FIG. 4B is a side view of the male-splined shaft.

FIG. 5 is a side view of the male-splined shaft and lamp assembly.

FIG. 6 is a perspective, schematic view showing coupling of the lamp assembly to a lamp mount via a spline mechanism.

### DETAILED DESCRIPTION OF THE INVENTION

Reference will now be made to the drawings wherein like numerals refer to like parts throughout. While the following description is made primarily with reference to a motorcycle, it should be understood that the lamp assembly of the present invention could as well be deployed on other types of vehicles.

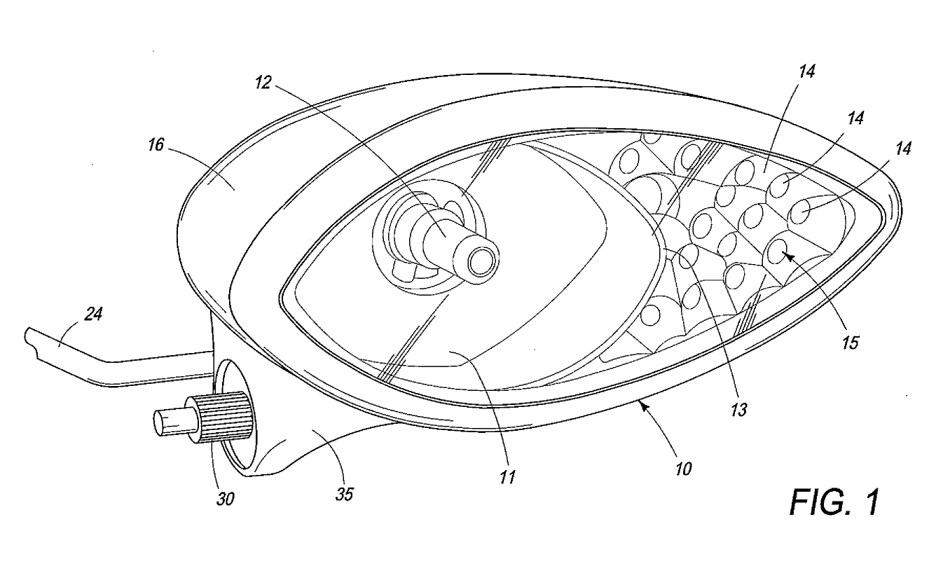

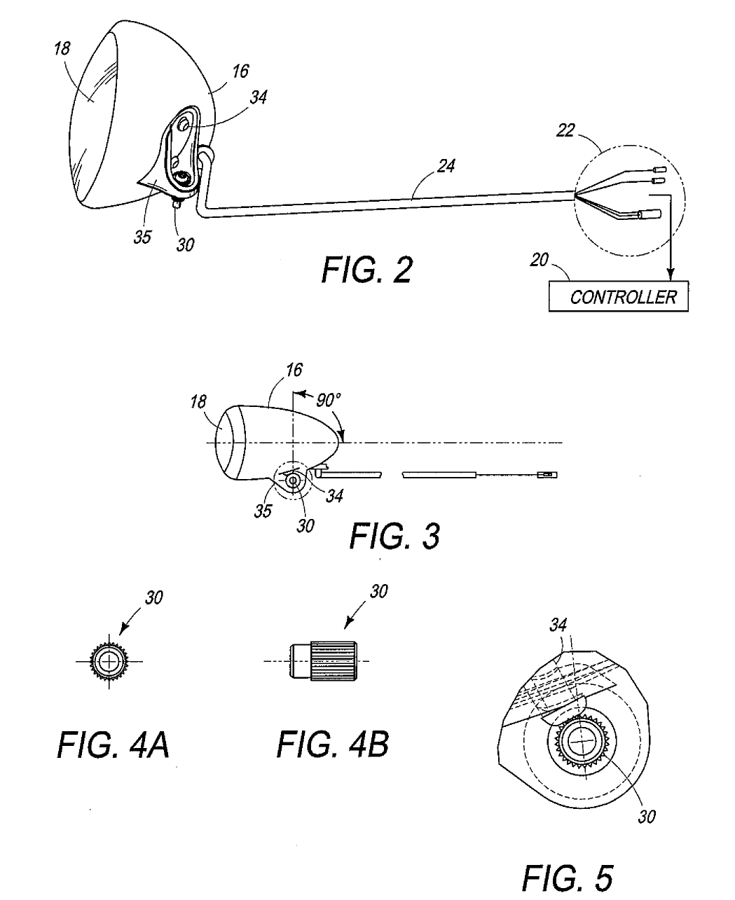

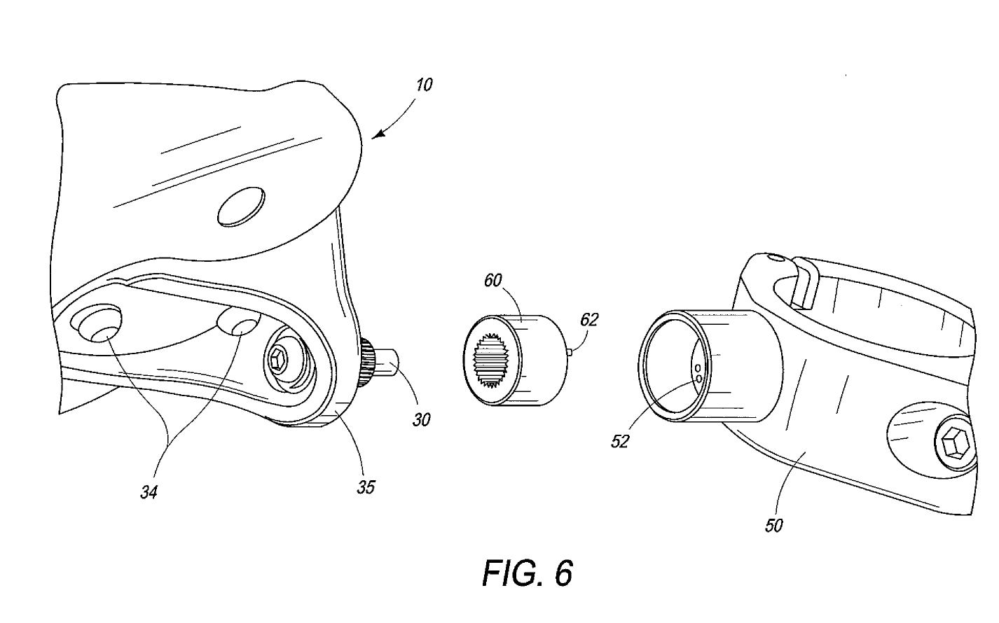

FIG. 1 is a perspective view of a lamp assembly 10. Lamp assembly 10 is a combined passing lamp and turn signal assembly. Lamp assembly 10 may be mounted on a motorcycle constructed and configured in a conventional manner. For example, lamp assembly 10 may be mounted onto a lamp mount 50 (FIG. 6), which in turn is mounted on a motorcycle of the type including a front wheel rotatably mounted on a front fork. The front fork is rotatably mounted on the front end of a main body frame, and a steering handle is mounted on the upper portion of front fork so that a rider may steer the motorcycle by rotating the front fork and its attached wheel. A headlight is mounted on the upper portion of the front fork. Lamp assembly 10 on lamp mount 50 may be mounted, for example, below the headlight and above the front wheel. As is known, the motorcycle will include other conventional components such as a rear wheel and a saddle seat, as well as an engine and transmission mounted within the body frame for driving the wheels.

Lamp assembly 10 includes at least one passing lamp bulb 12 and a plurality of LED lamps 14 mounted within a housing 16. In one embodiment, there is one passing lamp bulb and twenty-two LED lamps. Of course, other numbers of passing lamp bulbs and LED lamps may be utilized as appropriate. A divider wall 13 separates housing 16 into a passing lamp compartment or portion 11 in which passing lamp bulb 12 is contained, and a turn signal compartment or portion 15 in which LED lamps 14 are contained. A transparent lens 18 covers compartments 11 and 15, and allows light emitted from bulb 21 and lamps 14 to project outside of lamp assembly 10. In one embodiment, lens 18 is clear.

Passing lamp bulb 12 and LED lamps 14 are controlled by electrical signals received via wires or conductors 22 from a controller 20. Wires 22 are at least partially encased in a conduit or wrap 24 for protection from the external environment. Controller 20 may be a computer or microprocessor that executes instructions from a computer program stored in a computer readable medium, which may be implemented in hardware or software.

In one embodiment, controller 20 controls passing lamp bulb 12 and LED lamps 14 as follows. First, when the ignition of the motorcycle is powered, LED lamps 14 are turned on at a relatively low brightness to operate as running lamps. For example, when operating as running lamps, LED lamps 14 may operate at 20% of their maximum brightness. When a rider operates a turn signal mechanism (which may be located on or in the proximity of the handlebars, for example) controller 20 increases the brightness of LED lamps 14 to a relatively high level to signal a turn. LED lamps 14 may also be flashed as well as increased in brightness to signal a turn. For example, when operating as turn signals LED lamps 14 may operate at 100% of their maximum brightness.

In one embodiment, controller 20 controls passing lamp 12 and LED lamps 14 such that passing lamp 12 is turned off while LED lamps 14 are operating as turn signals. For example, if passing lamp 12 is ON, and the rider subsequently operates the turn signal mechanism to signal a turn, LED lamps 14 are turned ON by controller 20, and passing lamp 12 is turned OFF. In one embodiment, once the turn is completed and LED lamps 14 are returned by controller 20 to their operational state as running lamps at a reduced brightness, passing lamp 12 is returned to its ON state.

Assembly 10 is mounted to a lamp mount 50 (FIG. 6) in a front portion of the motorcycle so as to project light forward of the motorcycle. For example, lamp mount 50 may be positioned below the headlight and above the front wheel. Typically, two lamp assemblies 10 will be mounted to lamp mount 50; one on the far right side, and one on the far left side.

A lamp bracket 35 is mounted to the underside of lamp assembly 10. In one embodiment, lamp bracket 35 is mounted to the underside of housing 16 of lamp assembly 10 via rivets 34. A male-splined shaft 30 is coupled to and projects from bracket 35, and is selectively received by a female-splined adapter 60 that is coupled to lamp mount 50 to allow adjustment of the horizontal alignment of lamp assembly 10 relative to the road or running surface. Alternatively, a female-splined receptacle could be formed directly in lamp mount 50, rather than in a separate adapter. Moreover, it should also be understood that a male-splined shaft could be formed on or coupled to lamp mount 50, and a female-splined receptacle could be formed in or coupled to lamp assembly 10/bracket 35.

As shown in FIG. 6, male-splined shaft 30 is received by female-splined adapter 60. Adapter 60, in turn, has a locating pin 62 that fits into a locator hole 52 formed in passing lamp mount 50. Thus, lighting assembly 10 is mounted to passing lamp mount 50 via bracket 35, male-splined shaft 30, female-splined adapter 60, locator pin 62 and locator hole 52.

In one embodiment male-splined shaft 30 and female-splined adapter 60 have 30 teeth/grooves. Thus, the horizontal alignment of lamp assembly 10 can be adjusted at very precise 12 degree intervals relative to mount 50. Moreover, in one embodiment, two locator holes 52 are machined into lamp mount 50 and configured to allow adapter 60 to be further adjusted relative to mount 50. In one embodiment, by adjusting adapter 60 relative to mount 50 by selection of holes 52, and adjusting male-splined shaft 30 within adapter 60, lamp assembly 10 can be pivoted with a precision of six or three degrees. By operation of spline 30 and adapter 60, the horizontal alignment of lamp assembly 10 can be precisely aligned to thereby adjust the angle of projection of the light emitted from lamp assembly 10.

The particular embodiments of the invention described in this document should be considered illustrative, rather than restrictive. Modification to the described embodiments may be made without departing from the spirit of the invention as defined by the following claims.

1. A lamp assembly for a vehicle comprising:
a housing;
a passing lamp mounted within one portion of the housing; and
a turn signal mounted within another portion of the housing.

2. The lighting assembly of claim 1, wherein the housing comprises a divider wall that separates the housing into a passing lamp compartment in which the passing lamp is contained, and a turn signal compartment in which the turn signal is contained.

3. The lamp assembly of claim 1, and further comprising a controller for controlling the passing lamp and the turn signal.

4. The lamp assembly of claim 3, wherein the controller turns the passing lamp OFF when the turn signal is turned ON.

5. The lamp assembly of claim 3, wherein the turn signal comprises a plurality of LED lamps.

6. The lamp assembly of claim 5, wherein the controller operates the LED lamps at a relatively high brightness to operate as a turn signal, and at a relatively low brightness to operate as running lamps.

7. The lamp assembly of claim 6, wherein the LED lamps are operated at 100% of their maximum brightness when operating as a turn signal, and are operated at 20% of their maximum brightness when operating as running lamps.

8. The lamp assembly of claim 1, and further comprising:
a lamp mount on which the lamp assembly is mounted;
a male-splined shaft projecting from the lamp assembly; and
a female-splined receptacle coupled to the lamp mount that receives the male-splined shaft.

9. The lamp assembly of claim 8, wherein the female-splined receptacle is an adapter that is coupled to the lamp mount.

10. The lamp assembly of claim 9, wherein the adapter has a locator pin that is received in a locator hole of the lamp mount.

11. The lamp assembly of claim 10, wherein the male-splined shaft has thirty teeth such that the orientation of the lamp assembly relative to the passing lamp mount can be adjusted at twelve degree intervals.

12. The lamp assembly of claim 11, wherein the multiple locator holes are formed in the lamp mount to allow greater control over the orientation of the lamp assembly.

13. A motorcycle comprising the lamp assembly of claim 1.

14. A motorcycle comprising the lamp assembly of claim 8.
